(19) United States
(12) Patent Application Publication
(10) Pub. No.: US 2010/0177347 A1
(43) Pub. Date: Jul. 15, 2010

(54) IMAGE FORMING PROCESSING CONTROLLER AND METHOD AND COMPUTER-READABLE MEDIUM THEREOF

(75) Inventor: Masateru Mitani, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/686,795

(22) Filed: Jan. 13, 2010

Related U.S. Application Data
(60) Provisional application No. 61/144,998, filed on Jan. 15, 2009.

(51) Int. Cl. G06F 3/12

(52) U.S. Cl. 358/1.15

(57) ABSTRACT

To provide a technique for enabling formation of a background pattern image even if a dedicated computer program corresponding to an image forming apparatus caused to execute image formation processing is not installed in an apparatus configured to instruct the image formation processing. An image-formation-processing control apparatus includes: a unit-pattern acquiring unit configured to acquire, via a network, unit patterns used for formation of a background pattern image in image forming apparatuses that are instruction targets of image formation processing; and a PDL-data generating unit configured to generate PDL data in which information used for specifying a shape of a background pattern image that should be formed and the unit patterns used for formation of a background pattern image in an image forming apparatus caused to execute the image formation processing are associated.

### CROSS-REFERENCE TO RELATED APPLICATION

This application is based upon and claims the benefit of priority from U.S. provisional application 61/144998, filed on Jan. 15, 2009, the entire contents of each of which are incorporated herein by reference.

### TECHNICAL FIELD

This specification relates to a technique for performing printing such that characters or the like stand out against the background of a print when the print is copied, i.e., forming a so-called background pattern image, and, more particularly, to a background pattern image forming process on a client computer side.

### BACKGROUND

In the related art, so-called background pattern print processing for performing printing such that characters, figures, or the like standout against the background of a print when copied is performed.

In the background pattern printing, for example, a background pattern image is formed by using two kinds of unit patterns, i.e., an unreadable pattern formed by fine dots that a copy machine cannot recognize when copied and a readable pattern formed by large dots that the copy machine can recognize. Consequently, an unreadable pattern area of the background pattern image is not read nor printed at all and a readable pattern area is directly printed with a shape thereof kept. Therefore, it is possible to cause characters or figures formed by the readable pattern area to standout against the background of a print.

When the background pattern print processing is performed, there are the following two methods for the processing: (1) a method of creating print data (e.g., PDL data) in which a background pattern image is incorporated on a client computer side, transmitting the print data to a MFP (Multi Function Peripheral) (or a printer), and printing the print data; and (2) a method of performing processing for incorporating a background pattern in print data (in which a background pattern is not incorporated) acquired from the client computer by the MFP and printing the print data.

In the method (1), for example, a printer driver corresponding to the MFP caused to execute background pattern print processing is installed in the client computer in advance. The client computer performs processing for forming a background pattern image using unit patterns corresponding to the MFP incorporated in the printer driver installed therein and forming print data in which the background pattern image is incorporated as the background of a print.

In recent years, there is a demand for so-called universalization of a printer driver for allowing printing in various MFPs with a single printer driver. However, in some case, unit patterns for forming a background pattern image in each of MFPs are different depending on a hardware characteristic of the MFP. Therefore, when background pattern print processing is performed by the background pattern printing method (1), as unit patterns of a MFP available after the completion of development of the printer driver, it is necessary to add unit patterns anew by, for example, updating the printer driver. Therefore, a universal driver has to be updated every time a new MFP is released. The universalization of a printer driver cannot be sufficiently attained.

### SUMMARY

It is an object of an embodiment of the present invention to provide a technique for enabling formation of a background pattern image even if a dedicated computer program corresponding to an image forming apparatus caused to execute image formation processing is not installed in an apparatus configured to instruct the image formation processing.

In order to solve the problem, this specification relates to an image-formation-processing control apparatus including: a unit-pattern acquiring unit configured to acquire, via a network, unit patterns used for formation of a background pattern image in image forming apparatuses that are instruction targets of image formation processing; and a PDL-data generating unit configured to generate PDL data in which information used for specifying a shape of a background pattern image that should be formed and the unit patterns used for formation of a background pattern image in an image forming apparatus caused to execute the image formation processing are associated.

This specification relates to an image-formation-processing control method including: acquiring, via a network, unit patterns used for formation of a background pattern image in image forming apparatuses that are instruction targets of image formation processing; and generating PDL data in which information used for specifying a shape of a background pattern image that should be formed and the unit patterns used for formation of a background pattern image in an image forming apparatus caused to execute the image formation processing are associated.

This specification relates to a computer-readable recording medium having recorded therein an image-formation-processing control program for causing a computer to execute processing for: acquiring, via a network, unit patterns used for formation of a background pattern image in image forming apparatuses that are instruction targets of image formation processing; and generating PDL data in which information used for specifying a shape of a background pattern image that should be formed and the unit patterns used for formation of a background pattern image in an image forming apparatus caused to execute the image formation processing are associated.

### DESCRIPTION OF THE DRAWINGS

FIG. 1 is a system diagram of a system including a client computer and MFPs;

FIG. 2 is a functional block diagram of the client computer;

FIG. 3 is a functional block diagram of each of the MFPs;

FIG. 4 is a diagram of a background pattern image formed by an unreadable unit pattern and a readable unit pattern;

FIG. 5 is a diagram of a print formed when the background pattern image shown in FIG. 4 is copied;

FIG. 6 is a diagram of the unreadable unit pattern;

FIG. 7 is a diagram of the readable unit pattern;

FIG. 8 is a flowchart for explaining a flow of processing by the client computer for instructing the MFP to execute print processing;

FIG. 9 is a flowchart for explaining a flow of the print processing executed in the MFP; and

FIG. 10 is a system diagram of a system according to another embodiment including a client computer, MFPs, and a server.

### DETAILED DESCRIPTION

Embodiments of the present invention are explained below with reference to the accompanying drawings.

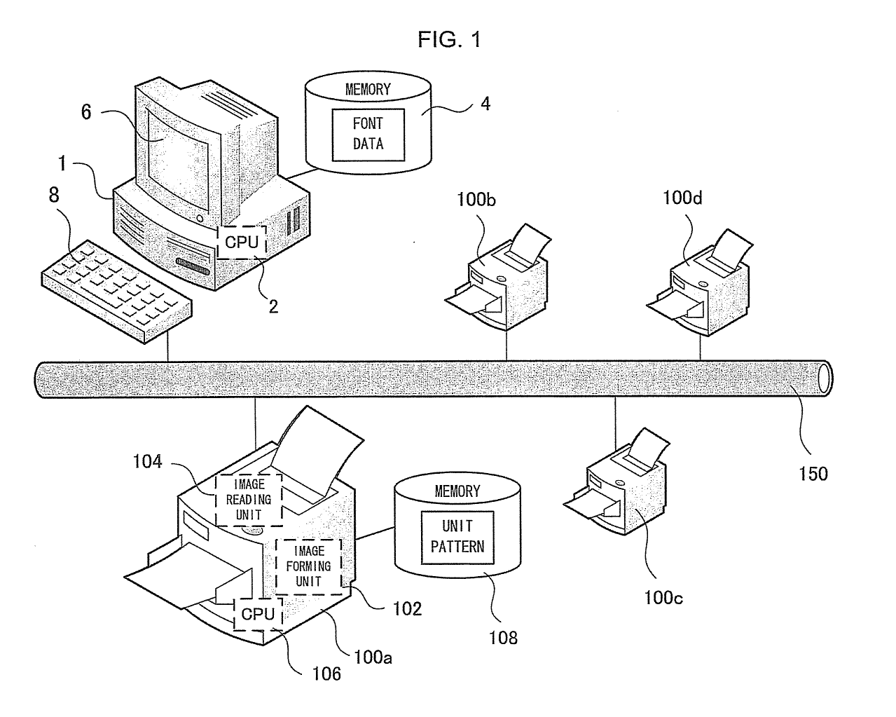

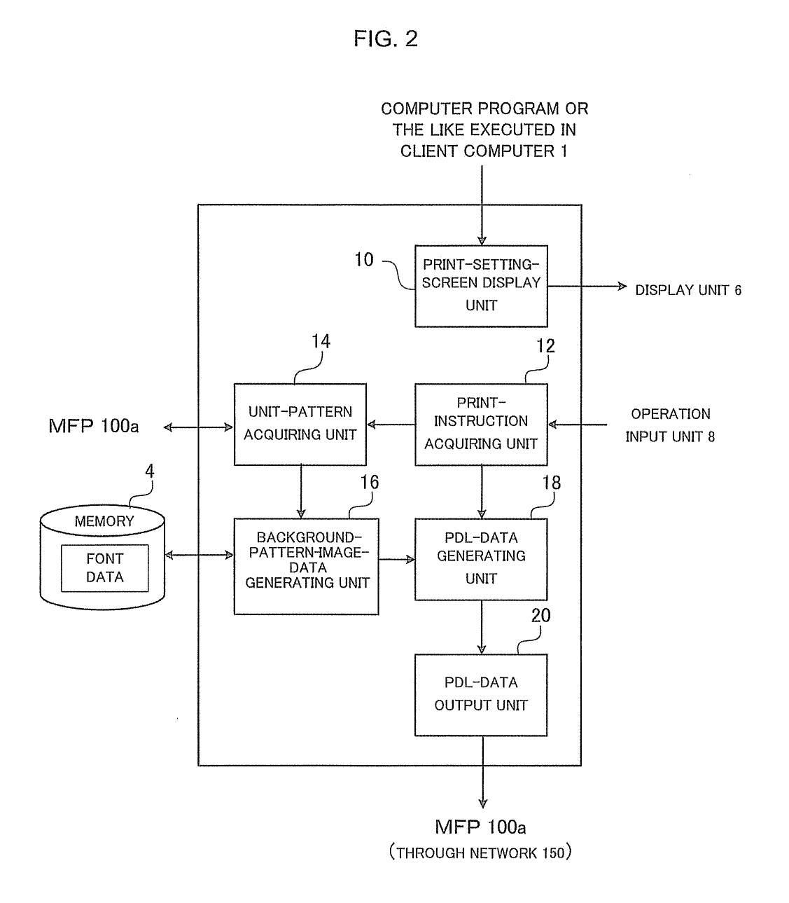

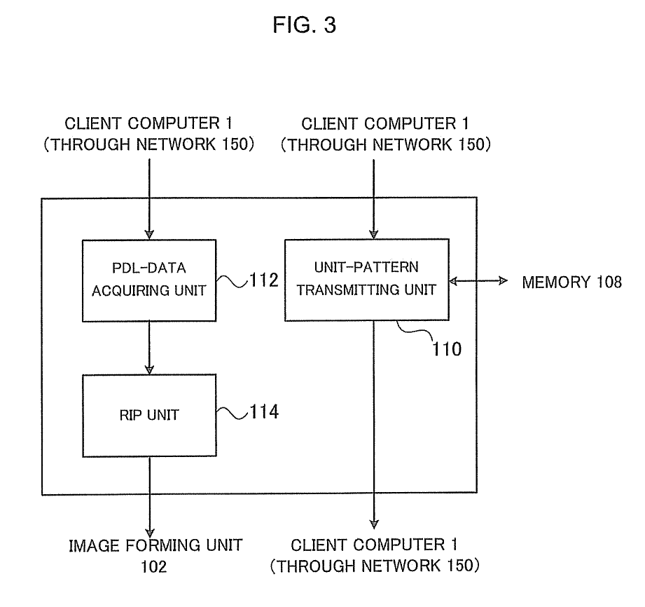

FIG. 1 is a system diagram of a system including a client computer 1 as an apparatus configured to instruct image formation processing and MFPs (Multi Function Peripherals) 100a to 100d as image forming apparatuses according to an embodiment of the present invention. The client computer 1 and the MFPs 100a to 100d are connected via a network. FIG. 2 is a functional block diagram of the client computer 1 according to this embodiment. FIG. 3 is a functional block diagram of the MFPs 100a to 100d according to this embodiment.

The system according to this embodiment includes the client computer 1 configured to output, to the MFPs 100a to 100d via a network 150, an instruction for causing the MFPs 100a to 100d to execute image formation (print) processing and the MFPs 100a to 100d configured to receive the instruction for the print processing output by the client compute 1 and execute the print processing on the basis of the instruction for the print processing acquired via the network 150. The MFPs 100a to 100d are examples of MFPs as targets instructed by the client computer 1 to execute the print processing. Besides, any MFPs and printers connected to the client computer 1 via a network can be instructed by the client computer 1 to execute the print processing.

The network 150 for connecting the client computer 1 and the MFPs 100a to 100d can include the Internet, a LAN (Local Area Network), or a WAN (Wide Area Network)

The configurations of the apparatuses included in the system shown in FIG. 1 are explained below.

The client computer 1 is a general computer and includes a CPU 2, a memory 4, a display unit 6, and an operation input unit 8 such as a keyboard and a mouse. The client computer 1 can output, to the MFPs 100a to 100d connected via the network 150, an instruction for causing the MFPs 100a to 100d to print a processing result or the like of a computer program executed in the client computer 1.

Further, the client computer 1 according to this embodiment can output, to the MFPs 100a to 100d, an instruction for causing the MFPs 100a to 100d to execute print processing (hereinafter also referred to as background pattern print processing) for forming a specific background pattern image on the background of a print. When the background pattern print processing is executed, the client computer 1 acquires, from an MFP that the client computer 1 instructs to execute the print processing, unit patterns of a background pattern image used for formation of a background pattern image in the MFP. The client computer 1 generates PDL (Page Description Language) data as a job file for instructing the MFP to print an image obtained by combining data to be printed (data of a document and an image displayed by a computer program executed by the client computer 1) and a background pattern image formed by using the acquired unit patterns. The client computer 1 can cause, by outputting the generated PDL data to the MFP, the MFP to execute the background pattern print processing.

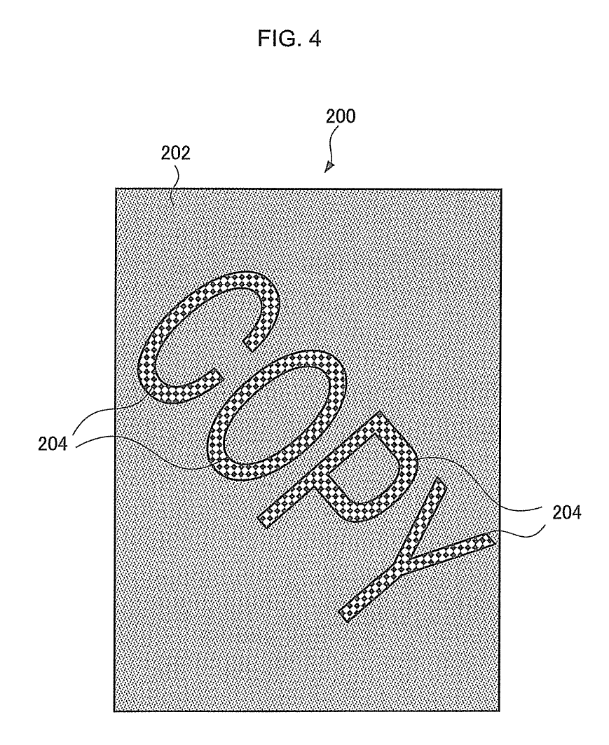

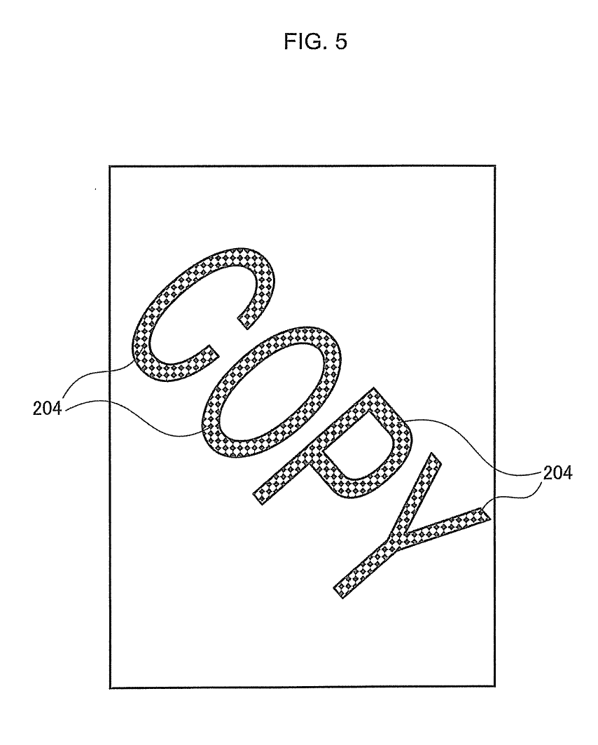

The “background pattern image” is an image formed on the background of a print such that characters, figures, or the like stand out when the print is copied. The background pattern is also called “ground pattern”, “anti-scan/anti-copy pattern” and so on. In FIG. 4, as an example, a background pattern image 200 in which characters “COPY” stand out when copied is shown. The background pattern image 200 includes an unreadable area 202 as an area formed by a background pattern of fine dots that a reading apparatus such as a copying machine cannot read and a readable area 204 as an area formed by a background pattern of dots having readable size. In this case, when a print on which the background pattern image 200 is formed is copied, only the readable area 204 is read and printed. As shown in FIG. 5, only the characters “COPY” remain. In this way, specific characters or the like are caused to stand out on a copy. This makes it possible to distinguish an original and the copy.

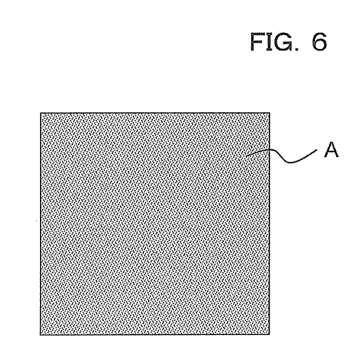

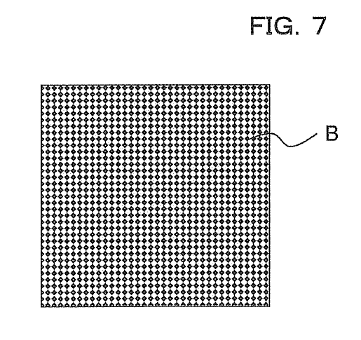

The “unit patterns” are minimum units of a background pattern used for generation of the background pattern image in the MFP. For example, in this embodiment, as the unit patterns, an unreadable pattern A shown in FIG. 6 and a readable pattern B shown in FIG. 7 are used. The unreadable pattern A is a pattern for forming the unreadable area 202 of the background pattern image 200. The readable pattern B is a pattern for forming the readable area 204. The unreadable pattern A and the readable pattern B are, for example, 240 dots×240 dots square images. A background pattern image is formed by laying these two kinds of patterns. As the unit patterns, different unit patterns having different sizes of dots and different states of dispersion of the dots are often used for each type of an MFP.

The “PDL data” is a text file obtained by describing, with a page description language, data of a document, an image, for the like that is about to be printed. The MFP that receives the PDL data performs processing for interpreting the PDL data and forming a raster image and performs print processing. When background pattern printing is performed, as explained above, the MFP outputs the PDL data including an instruction for forming, using the unit patterns, a background pattern image on the background of the data that is about to be printed.

In FIGS. 4 to 7, the unreadable pattern A and the readable pattern B are indicated by clearly different patterns to facilitate understanding that the unreadable pattern A and the readable pattern B are different patterns. However, actually, two kinds of unit patterns for preventing the characters “COPY” from standing out to be seen are used in the background pattern image shown in FIG. 4.

The CPU 2 controls various kinds of processing in the client computer 1. In this embodiment, the CPU 2 performs processing for starting a printer driver stored in the memory 4 and generating the PDL data for causing the MFP to execute the print processing and processing for outputting the PDL data as an instruction for causing the MFP to perform the print processing. The “printer driver” is a computer program for allowing the client computer 1 to use various functions such as the print processing of the MFP.

The memory 4 stores various computer programs and data. In this embodiment, the memory 4 stores the printer driver. The memory 4 can include a RAM (Random Access Memory), a ROM (Read Only Memory), a DRAM (Dynamic Random Access Memory), a SRAM (Static Random Access Memory), or a VRAM (Video RAM).

Each of the MFPs 100a to 100d has plural functions such as a copy function, a scan function, a facsimile function, and a printer function and includes an image forming unit 102, an image reading unit 104, a CPU 106, and a memory 108. As explained above, when each of the MFPs 100a to 100d receives the PDL data via the network 150, the MFP generates a raster image from the PDL data and executes the print processing. In this embodiment, when the MFP receives an instruction requesting the unit patterns from the client computer 1, the MFP performs processing for transmitting the unit patterns.

The image forming unit 102 performs printing on a sheet such as paper when the image forming unit 102 receives a print instruction from the client computer 1 or when copying is performed.

The image reading unit 104 reads an original document when scanning or copying is performed.

The CPU 106 controls print processing in the image forming unit 102 and various kinds of processing such as reading processing in the image reading unit 104. The CPU 106 according to this embodiment performs, when PDL data is acquired via the network 150, processing for analyzing the acquired PDL data and generating a raster image.

The memory 108 stores various computer programs to be executed by the CPU 106, data, and the like. In this embodiment, the memory 108 stores a computer program for performing the processing for analyzing PDL and generating a raster image (a RIP program) and unit patterns of a background pattern image used for generation of the background pattern image in the MFPs.

Processing for outputting an instruction for causing the MFP to execute background pattern print processing in the client computer 1 is explained with reference to FIG. 2. In the following explanation, it is assumed that the MFP instructed to execute the print processing is the MFP 100a. As the background pattern image, the background pattern image shown in FIG. 4 in which the characters “COPY” stand out when a print is copied is generated.

The client computer 1 includes a print-setting-screen display unit 10, a print-instruction acquiring unit 12, a unit-pattern acquiring unit 14, a background-pattern-image-data generating unit 16, a PDL-data generating unit 18, and a PDL-data output unit 20.

First, for example, a computer program being executed in the client computer 1 is about to be printed, the print-setting-screen display unit 10 receives an operation input for executing the print processing and displays a print setting screen. The print setting screen is a screen for selecting the MFP caused to execute the print processing out of the MFPs (e.g., the MFPs 100a to 100d), to which an instruction for execution of the print processing can be transmitted, and performing, for example, setting of various print conditions such as the number of prints and color or white and black, setting of presence or absence of background pattern printing, and selection of a format such as characters to be displayed as a background pattern and a font of the characters. When a user presses a button for executing printing on the print setting screen, an instruction for causing the MFP to execute printing according to the conditions set on the setting screen is output.

When an instruction for causing the MFP to execute printing is performed on the print setting screen, the print-instruction acquiring unit 12 acquires the print instruction and data to be printed. The print-instruction acquiring unit 12 acquires a print instruction including an instruction for performing background pattern printing because execution of the background pattern printing is set on the print setting screen. Then, the print-instruction acquiring unit 12 instructs the unit-pattern acquiring unit 14 to acquire unit patterns used for generation of a background pattern image in MFP 100a caused to execute the print processing. Information for specifying the MFP caused to execute the print processing is included in the print instruction acquired by the print-instruction acquiring unit 12.

The unit-pattern acquiring unit 14 requests, on the basis of the instruction of the print-instruction acquiring unit 12, the MFP 100a to transmit the unit patterns used for formation of a background pattern image by the MFP 100a and acquires the unit patterns from the MFP 100a.

The background-pattern-image-data generating unit 16 associates the unit patterns acquired by the unit-pattern acquiring unit 14 and information for specifying a shape of the background pattern image to be formed by the MFP 100a and generates background pattern image data as a command for generating the background pattern image. Specifically, the background-pattern-image-data generating unit 16 acquires, from the memory 4, font data of a font of characters to be displayed as a background pattern (e.g., data of a font selected out of plural True Type Fonts) included in the instruction for the background pattern printing. The background-pattern-image-data generating unit 16 determines, on the basis of the acquired font data and other information concerning format setting, a shape of a character portion to be formed in the background pattern image and specifies a shape (a contour) of the entire background pattern image that should be formed by the MFP 100a. For example, in the case of the background pattern image 200 shown in FIG. 4, the background-pattern-image-data generating unit 16 specifies shapes of the unreadable area 202 and the readable area 204 on the basis of information such as the position, the size, the direction, and the font of the characters “COPY” to be formed. The background-pattern-image-data generating unit 16 associates the data for specifying the shape of the background pattern image and the acquired unit patterns and generates background pattern image data as a command for generating the background pattern image. The position, the size, the direction, and the like of the characters for specifying the shape of the background pattern image may be set on the print setting screen or setting determined in advance maybe applied as the information.

The PDL-data generating unit 18 generates PDL data to be printed by the MFP 100a using the print data acquired by the print-instruction acquiring unit 12 and the background pattern image data generated by the background-pattern-image generating unit 16.

The PDL-data output unit 20 outputs, as an instruction for causing the MFP 100a to execute the print processing, the generated PDL data to the MFP 100a via the network 150.

The functions realized by the client computer 1 according to this embodiment are explained above. The functions of the client computer 1 are realized by the CPU 2 executing the computer program (the printer driver) stored in the memory 6.

Processing for executing the print processing in the MFP is explained below with reference to FIG. 3. As an example, the print processing is executed by the MFP 100a.

The MFP 100a includes a unit-pattern transmitting unit 110, a PDL-data acquiring unit 112, and a RIP unit 114.

When an instruction for requesting the unit patterns is received from the client computer 1 via the network 150, the unit-pattern transmitting unit 110 transmits the unit patterns to be used for formation of a background pattern image in the MFP 100a to the client computer 1.

The PDL-data acquiring unit 112 acquires the PDL data transmitted from the client computer 1 via the network 150.

The RIP unit 114 analyzes the PDL data acquired by the PDL-data acquiring unit 112 and converts the PDL data into a raster image (a bitmap image). The raster image converted from the PDL data by the RIP unit 114 is output to the image forming unit 102 and printed on a sheet.

The functions of the MFP according to this embodiment are explained above. The functions of the MFP are realized by the CPU 106 executing the computer program stored in the memory 108.

With the system including the configuration explained above, when an operation input for instructing the print processing is performed in the client computer 1, the client computer 1 can perform processing for acquiring, from the MFP instructed to execute the print processing, the unit patterns used for generation of the background pattern image in the MFP. Therefore, it is unnecessary to install, in the client computer 1 in advance, printer drivers corresponding to the respective MFPs including data of the unit patterns for performing the background pattern printing. This makes it easy to universalize a printer driver.

When the client computer 1 request the MFP to transmit the unit patterns and the MFP transmits the unit patterns to the client computer 1, the unit patterns may be transmitted and received after being encrypted. This is for the purpose of preventing the unit patterns as information concerning security of a print document from flowing out in communication.

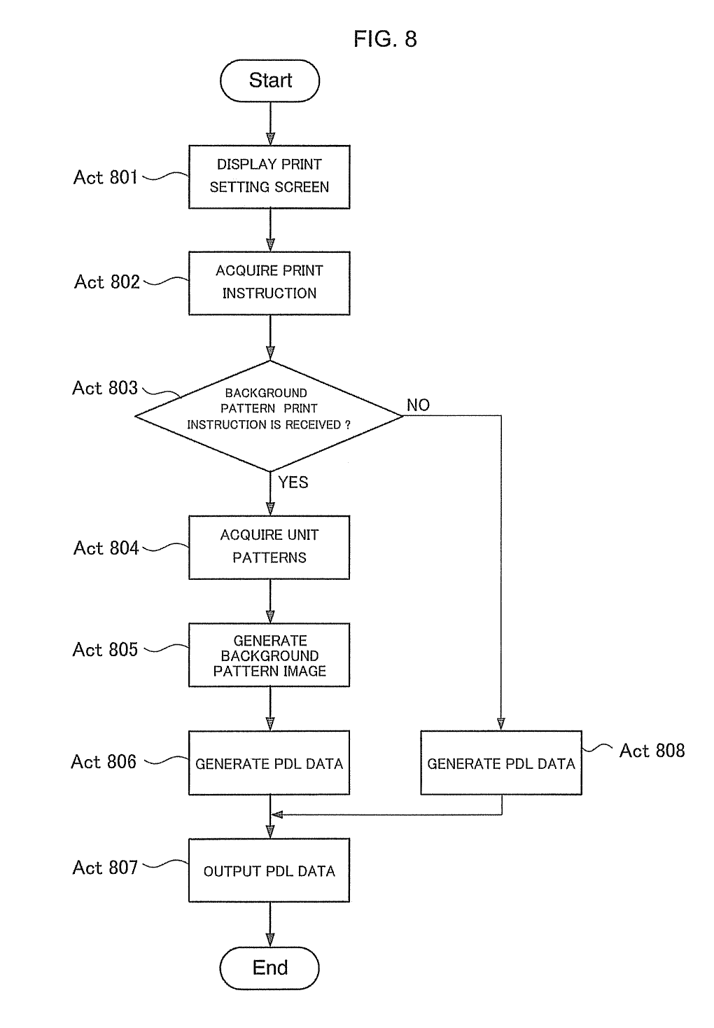

A flow of the processing by the client computer 1 for instructing the MFP 100a to execute the print processing is explained with reference to FIG. 8. FIG. 8 is a flowchart for explaining the flow of the processing by the client computer 1 for instructing the MFP to execute the print processing.

First, in Act 801 when an operation input for executing the print processing is performed in the client computer 1, the print-setting-screen display unit 10 displays a screen for setting print conditions. A user operates the operation input unit 8 and performs, for example, selection of the MFP caused to execute the print processing and selection of presence or absence of the background pattern print processing. An execution instruction for the print processing is output according to the depression of a button for instructing execution of the print processing.

In Act 802, the print-instruction acquiring unit 12 acquires the print instruction output in Act 801 and data to be printed.

In Act 803, the print-instruction acquiring unit 12 determines whether an instruction for performing the background pattern print processing is included in the acquired print instruction.

If it is determined in Act 803 that the instruction performing the background pattern print processing is included in the print instruction, in Act 804, the unit-pattern acquiring unit 14 requests the MFP 100a caused to execute the background pattern print processing to transmit the unit patterns and obtains the unit patterns from the MFP 100a.

In Act 805, the background-pattern-image-data generating unit 16 generates background pattern image data on the basis of the unit patterns acquired in Act 804 and information for specifying a shape of a background pattern image including the font data read out from the memory 4.

In Act 806, the PDL-data generating unit 18 generates PDL data using the data to be printed and the background pattern image data.

In Act 807, the PDL-data output unit 20 transmits the PDL data generated in Act 806 to the MFP 100a caused to execute the print processing via the network 150.

If the print-instruction acquiring unit 12 determines in Act 803 that the instruction for performing the background pattern print processing is not included in the acquired print instruction, in Act 808, the PDL-data generating unit 18 directly converts, from the print instruction and the data to be printed, the print data into PDL data.

In Act 807, the PDL-data generating unit 18 transmits the PDL data generated in Act 808 to the MFP 100a.

The flow of the processing for performing the background pattern print processing and performing the normal print processing without performing the background pattern printing in the client computer 1 is explained above.

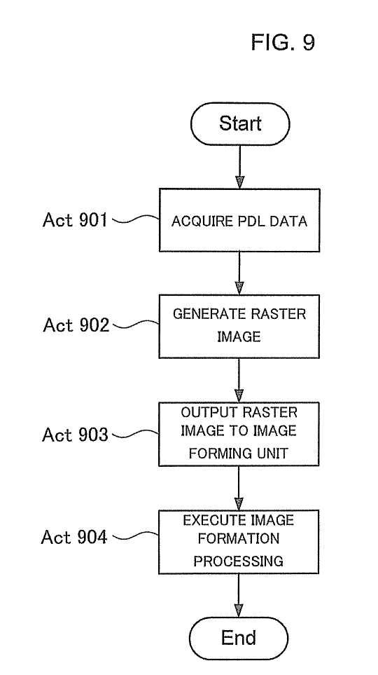

A flow of the print processing executed by the MFP 100a is explained below with reference to FIG. 9. FIG. 9 is a flowchart for explaining the flow of the print processing executed by the MFP 100a.

In Act 901, the PDL-data acquiring unit 112 acquires PDL data transmitted from the client computer 1 via the network 150.

In Act 902, the RIP unit 114 analyzes the acquired PDL data and generates a raster image from the PDL data. When the raster image is generated, if an instruction for forming a background pattern image on the background of a print is included in the PDL data, a raster image including the background pattern image formed on the background of an image of a document to be printed or the like is generated. On the other hand, if normal printing is performed rather than the background pattern printing, a raster image including only the image of the document to be printed or the like is generated.

In Act 903, the RIP unit 114 outputs the generated raster image to the image forming unit 102.

In Act 904, the image forming unit 102 prints the generated raster image.

The flow of the print processing in the MFP 100a is explained above.

As explained above, with the client computer 1 according to this embodiment, after the operation input for instructing execution of the print processing is performed, it is possible to perform the processing for acquiring, from the MFP instructed to execute the print processing, the unit patterns used for formation of a background pattern image in the MFP. Consequently, even when the MFPs as targets of an instruction of print processing respectively use different unit patterns, it is possible to form a background pattern image using the unit patterns corresponding to the MFP instructed to execute the print processing and it is possible to cause any MFP to execute the processing for forming a background pattern image. Therefore, it is unnecessary to separately install, in the client computer 1, printer drivers including unit patterns corresponding to the respective MFPs. Further, even when a universalized printer driver is used, as unit patterns available after installation of the printer driver, unit patterns used in execution of the print processing are acquired. Therefore, it is unnecessary to update the printer driver to acquire the unit patterns.

Since the client computer 1 is allowed to form a background pattern image in this way, the font installed in the client computer 1 can be used. Therefore, various background pattern images can be formed. If the True Type Font is used as the font, it is possible to check, on the screen of the client computer 1, a background pattern image having a shape same as a shape of a background pattern image to be printed. Therefore, it is possible to check, before printing, a background pattern image formed on the background of the data to be printed.

In the explanation of this embodiment, when the client computer 1 outputs an instruction for causing the MFP to execute the print processing, the client computer 1 acquires the unit patterns from the MFP that is a target of the instruction. However, the present invention is not limited to this. For example, when the print processing is not performed in the MFP or at predetermined timing arbitrarily set by the user, processing for acquiring in advance the unit patterns from the MFP that could be an instruction target of the print processing may be performed. When update or the like of firmware of the MFP is performed and the unit patterns used in the MFP are changed or added, the MFP may be caused to voluntarily transmit the unit patterns and the client computer 1 may acquire the unit patterns. In this case, when the client computer 1 outputs the instruction for causing the MFP to execute the print processing, it is unnecessary to perform the processing for acquiring the unit patterns. Therefore, it is possible to reduce time until PDL data is generated and complete printing earlier.

In the explanation of this embodiment, when the background pattern printing is performed, the unit patterns are always acquired from the MFP caused to execute the print processing. However, the present invention is not limited to this. If it is likely that the unit patterns are already acquired, it is also possible to perform processing for determining whether the unit patterns of the MFP caused to execute the print processing are acquired by the client computer 1 and acquiring the unit patterns if the unit patterns are not acquired.

For example, as explained above, when the client computer 1 acquires the unit patterns in advance prior to the print processing or when the unit patterns once acquired are stored and accumulated in a memory or the like, the processing for acquiring the unit patterns in outputting a print instruction to the MFP explained in the embodiment is not performed. Instead, the background-pattern-image-data generating unit 16 selects the unit patterns corresponding to the MFP caused to execute the print processing out of plural unit patterns accumulated in the memory and performs the processing for generating background pattern image data.

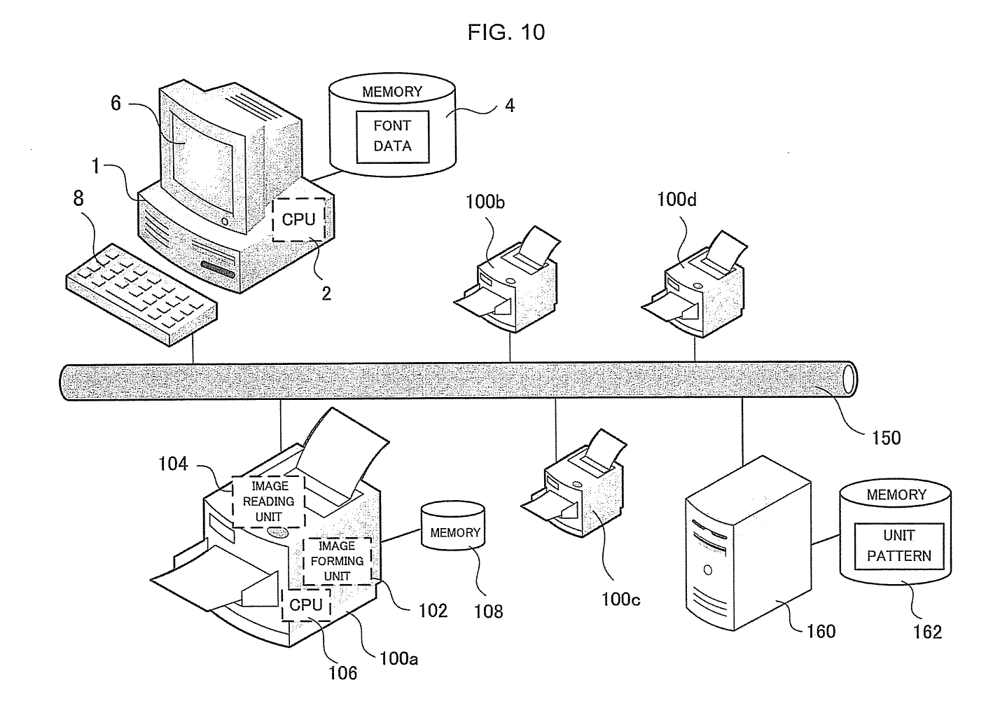

In the explanation of this embodiment, the unit patterns are stored in the memory of the MFP and the client computer 1 acquires the unit patterns from the MFP. However, the present invention is not limited to this. For example, as shown in FIG. 10, unit patterns used for formation of a background pattern image in the MFPs may be stored in a server 160 connected to the network 150 and the client computer 1 may acquire the unit patterns corresponding to the MFP caused to execute the print processing from the server 160.

In the explanation of this embodiment, in the background pattern image, the characters caused to stand out are formed by the readable pattern B. However, the present invention is not limited to this. The portion of the characters cause to stand out may be formed by the unreadable pattern A and the other portions may be formed by the readable pattern B. In this case, when a print having the background pattern image formed thereon is copied, the portion of the characters appears as white void.

In the explanation of this embodiment, the two kinds of unit patterns, i.e., the unreadable pattern and the readable pattern are acquired as the unit patterns used for formation of a background pattern image. However, the present invention is not limited to this. For example, when a unit pattern depending on functions and abilities of the MFPs is one of the patterns, the client computer 1 may acquire one of the unit patterns from the MFP and use, as the other unit pattern, a unit pattern incorporated in advance in (the printer driver of) the client computer 1. In this case, a background pattern image is formed by combining the unit pattern acquired from the MFP and the unit pattern incorporated in the printer driver.

In the explanation of this embodiment, when the client computer 1 performs the processing for instructing execution of the print processing, the print-setting-screen display unit 10 displays the print setting screen. However, it is not always necessary to display the print setting screen. For example, it is also possible to directly output a print instruction without displaying the print setting screen or output the print instruction in a CUI (Character User Interface)

In the explanation of this embodiment, there are the plural MFPs as the instruction targets of the print processing. However, the present invention is not limited to this. The client computer 1 may be connected to a single MFP. Even in this case, there is an effect that it is possible to generate a background pattern image in the client computer 1 and generate PDL data incorporating the background pattern image without installing a printer driver exclusive for the MFP in the client computer 1.

Further, a computer program for causing the client computer 1 to execute the respective kinds of processing explained above can be provided as a print processing execution instructing program. In the example explained in the embodiment, the computer program for realizing the functions for carrying out the invention is recorded in advance in the storage area provided in the apparatus. However, the present invention is not limited to this. The same program may be downloaded from the network to the apparatus. The same program stored in a computer-readable recording medium may be installed in the apparatus. The recording medium may be a recording medium of any form as long as the recording medium can store a computer program and can be read by the computer. Specifically, examples of the recording medium include internal storage devices internally mounted in the computer such as a ROM and a RAM, portable storage media such as a CD-ROM, a flexible disk, a DVD disk, a magneto-optical disk, and an IC card, a database that stores a computer program, another computer and a database thereof, and a transmission medium on a line. The function obtained by installation or download in advance in this way may be a function realized in cooperation with an OS (operating system) in the apparatus.

The computer program may be an execution module that is dynamically generated partially or entirely.

The present invention can be carried out in various forms without departing from the spirit and the main characteristic thereof. Therefore, the present invention is only an illustration in every aspect and should not be limitedly interpreted. The scope of the present invention is indicated by the scope of claims and is by no means limited by the text of the specification. Further, all modifications and various improvements, substitutions, and alterations belonging to the scope of equivalents of the scope of claims are within the scope of the present invention.

As explained above, according to the present invention, it is possible to provide a technique for enabling formation of a background pattern image even if a dedicated computer program corresponding to an image forming apparatus caused to execute image formation processing is not installed in an apparatus configured to instruct the image formation processing.

What is claimed is:

1. An image-formation-processing control apparatus comprising:
a unit-pattern acquiring unit configured to acquire, via a network, unit patterns used for formation of a background pattern image in image forming apparatuses that are instruction targets of image formation processing; and
a PDL-data generating unit configured to generate PDL data in which information used for specifying a shape of a background pattern image that should be formed and the unit patterns used for formation of a background pattern image in an image forming apparatus caused to execute the image formation processing are associated.

2. The apparatus according to claim 1, wherein the unit-pattern acquiring unit acquires the unit patterns from the image forming apparatus caused to execute the image formation processing.

3. The apparatus according to claim 1, further comprising an image-formation-instruction acquiring unit configured to acquire an instruction for causing the image forming apparatus to execute the image formation processing, wherein
the unit-pattern acquiring unit acquires the unit patterns when an instruction for causing the image forming apparatus to execute processing for forming the background pattern image is included in the instruction for causing the image forming apparatus to execute the image formation processing acquired by the image-formation-instruction acquiring unit.

4. The apparatus according to claim 1, wherein the unit patterns are a unit pattern formed by a pattern readable by a reading apparatus and a unit pattern formed by a pattern unreadable by the reading apparatus.

5. The apparatus according to claim 1, further comprising a memory configured to store font data, wherein
the information used for specifying a shape of a background pattern image that should be formed is information including the font data.

6. The apparatus according to claim 5, wherein the font data is a True Type Font.

7. The apparatus according to claim 1, wherein the unit-pattern acquiring unit acquires encrypted unit patterns.

8. An image-formation-processing control method comprising:
acquiring, via a network, unit patterns used for formation of a background pattern image in image forming apparatuses that are instruction targets of image formation processing; and
generating PDL data in which information used for specifying a shape of a background pattern image that should be formed and the unit patterns used for formation of a background pattern image in an image forming apparatus caused to execute the image formation processing are associated.

9. The method according to claim 8, further comprising acquiring the unit patterns from the image forming apparatus caused to execute the image formation processing.

10. The method according to claim 8, further comprising:
acquiring an instruction for causing the image forming apparatus to execute the image formation processing; and
acquiring the unit patterns when an instruction for causing the image forming apparatus to execute processing for forming the background pattern image is included in the acquired instruction for causing the image forming apparatus to execute the image formation processing.

11. The method according to claim 8, wherein the unit patterns are a unit pattern formed by a pattern readable by a reading apparatus and a unit pattern formed by a pattern unreadable by the reading apparatus.

12. The method according to claim 8, further comprising acquiring font data, wherein
the information used for specifying a shape of a background pattern image that should be formed is information including the font data.

13. The method according to claim 12, wherein the font data is a True Type Font.

14. The method according to claim 8, further comprising acquiring encrypted unit patterns.

15. A computer-readable recording medium having recorded therein an image-formation-processing control program for causing a computer to execute processing for:
acquiring, via a network, unit patterns used for formation of a background pattern image in image forming apparatuses that are instruction targets of image formation processing; and
generating PDL data in which information used for specifying a shape of a background pattern image that should be formed and the unit patterns used for formation of a background pattern image in an image forming apparatus caused to execute the image formation processing are associated.

16. The recording medium according to claim 15, wherein the image-formation-processing control program causes the computer to further execute processing for acquiring the unit patterns from the image forming apparatus caused to execute the image formation processing.

17. The recording medium according to claim 15, wherein the image-formation-processing control program causes the computer to further execute processing for:
acquiring an instruction for causing the image forming apparatus to execute the image formation processing; and
acquiring the unit patterns when an instruction for causing the image forming apparatus to execute processing for forming the background pattern image is included in the acquired instruction for causing the image forming apparatus to execute the image formation processing.

18. The recording medium according to claim 15, wherein the unit patterns are a unit pattern formed by a pattern readable by a reading apparatus and a unit pattern formed by a pattern unreadable by the reading apparatus.

19. The recording medium according to claim 15, wherein the image-formation-processing control program causes the computer to further execute processing for comprising acquiring font data, wherein
the information used for specifying a shape of a background pattern image that should be formed is information including the font data.

20. The recording medium according to claim 19, wherein the font data is a True Type Font.
